(19) United States
(12) Patent Application Publication
(10) Pub. No.: US 2010/0282621 A1
(43) Pub. Date: Nov. 11, 2010

(54) SPRAY PRODUCT

(75) Inventors: Toshifumi Hatanaka, Hyogo-ken (JP); Masaki Okada, Shizuoka-ken (JP); Kiyotaka Miyata, Shizuoka-ken (JP); Teruo Miura, Shizuoka-ken (JP)

Correspondence Address: POSZ LAW GROUP, PLC, 12040 SOUTH LAKES DRIVE, SUITE 101, RESTON, VA, 20191, US

(73) Assignees: NKK CO., LTD., Himeji-shi ,Hyogo-ken (JP); SHOWA TANSAN CO., LTD., Tokyo-to (JP); Japan Petroleum Exploration Co., Ltd., Tokyo-to (JP)

(21) Appl. No.: 12/734,392

(22) PCT Filed: Feb. 29, 2008
(86) PCT No.: PCT/JP2008/053606

§ 371 Date: Jun. 8, 2010

(30) Foreign Application Priority Data
Nov. 1, 2007 (JP) 2007-285154

(51) Int. Cl. F17C 11/00; A47L 9/02

(52) U.S. Cl. 206/204; 15/405

(57) ABSTRACT

A high-quality spray product that uses a less expensive propellant exhibiting a lower ozone-depleting potential and a lower global warming potential without using any fluorocarbon, any alternative thereto, etc., and exhibits an improved safety and an improved liquid retention. A dust blower as the spray product uses a propellant composed of a mixture of dimethyl ether and carbon dioxide, and an absorbent adapted to retain the propellant, which is composed of an assembly of pulverized cellulose fibers such that the cellulose fibers include at least 45 mass % of fine cellulose fibers having a fiber length of 0.35 mm or less. The propellant and the absorbent are charged in a spray can having a spray nozzle, thereby preparing a dust blower.

### CROSS REFERENCE TO RELATED APPLICATIONS

This application is a U.S. national stage application of PCT/JP2008/053606 filed on Feb. 29, 2008, and claims priority to, and incorporates by reference, Japanese Patent Application No. 2007-285154 filed on Nov. 1, 2007.

### TECHNICAL FIELD

The present invention relates to a spray product that is produced by charging a propellant and an absorbent in a spray can and, more particularly, to a spray product that is preferably used as a dust blower adapted to blow off dust accumulated on various kinds of appliances.

### BACKGROUND ART

The dust blower normally has the arrangement that a disposable metallic spray can having a spray button is charged with a propellant such as a compressed gas or a liquefied gas, and the gas is sprayed by pushing the spray button.

Conventionally, fluorocarbons have been used as the propellant for the spray products such as dust blowers, but fluorocarbons are substances causing the depletion of the ozone layer, thereby generating a global problem, which results in that controls on usage of fluorocarbons become severe. Under these circumstances, another propellant exhibiting a smaller ozone-depleting potential has been developed, and now, alternatives to fluorocarbons, such as HFC 134a (CH₂F—CF₃) and HFC 152a (CH₃—CHF₂), have been used widely.

In the recent years, the protection of the global environment has become of major interest, and, not only the depletion of the ozone layer but also effects of such fluorocarbons on the environmental contamination, in particular, the global warming, which is caused by the emission of components of the propellant into the air, become serious problems to be solved.

HFC 134a as one of the alternatives to fluorocarbons is a non-flammable gas so as not to cause burning, but exhibits a global warming potential as high as 1300. HFC 152a exhibits a global warming potential as small as 140, but is an inflammable gas so as to cause generation of flames. In addition, these alternatives to fluorocarbons are fluorides so as to exhibit properties of generating a highly poisonous hydrofluoric acid when contacting an open fire, which causes a serious security problem. And, these alternatives to fluorocarbons are expensive so that the provision of inexpensive gases are demanded.

On the other hand, according to Law on Promoting Green Purchasing (Law Concerning the Promotion of Procurement of Eco-Friendly Goods and Services by the State and Other Entities), products which do not cause a large environmental impact due to the emission of greenhouse gases, etc. as a result of the use thereof is defined as the “eco-friendly goods”, and with respect to the dust blower, the “evaluation criteria” thereof is that the dust blower does not use substances exhibiting global warming potentials of 150 or higher. And the “factors for consideration” is that the dust blower does not use hydrofluorocarbons (alternatives to fluorocarbons). Therefore, it is highly demanded to shift the propellant to one exhibiting a smaller impact on the global environment.

In contrast, the present inventors have proposed in Patent Document 1 to use dimethyl ether (DME) which does not cause the depletion of the ozone layer and exhibits a very small global warming potential, and to combine the same with carbon dioxide as another component of the propellant. Dimethyl ether (DME) is inflammable, but by mixing carbon dioxide thereinto, flame retardant properties can be imparted to the propellant, thereby improving the safety thereof.

Patent Document 1: Publication of unexamined Patent Application No. 2005-206723.

Where the dust blower charged with a liquefied gas is used in an inverted position, the liquefied gas may leak from a nozzle thereof in a liquid phase. In order to prevent the leakage of the liquefied gas, in Patent Document 1, the spray can is charged with waste papers, etc., which are used as an absorbent for retaining the liquefied gas. And, now, in many cases, the absorbent of the spray can is prepared by pulverizing waste papers, etc., wrapping the same with a nonwoven fabric, and forming the wrapped waste papers into a cylindrical configuration, or by molding a foamed urethane etc. into such a configuration.

However, the pulverized waste papers have been subjected to recycling once or more times, and consequently, damaged fibers are included so that the liquid retaining force thereof is not good. In addition, since the quality of raw materials scatters, the liquid retaining force may not become identical, and the amount of the absorbent required for every can may be not constant. And, in many cases, impurities such as a printing ink, etc. have adhered to the waste papers so that surfaces of fibers are likely to repel liquid, thereby degrading the liquid absorbability. Consequently, when the spray can is used or stored in an inverted position, liquid may leak therefrom. And, various kinds of ink components included in the waste papers are dissolved in a liquefied gas or react therewith to color the liquefied gas, thereby causing coloring troubles due to the colored liquefied gas when sprayed.

Under these circumstances, the present inventors have proposed in Japanese patent application No. 2006-348736 an absorbent for a spray can, which is composed of an assembly of pulverized cellulose fibers, and includes a prescribed amount or more of fine cellulose fibers having a fiber length of 0.35 mm or less. This absorbent includes fine fibers obtained by pulverizing cellulose fibers with mechanical or chemical means, and is excellent in absorbing performance and liquid retention.

Examples of the prior art concerning the pulverizing technique of the cellulose fibers include Patent documents 2 through 4.

Patent document 2: Publication of examined Patent Application No. Sho60-19921

Patent document 3: Publication of examined Patent Application No. Sho63-44763

Patent document 4: Publication of unexamined Patent Application No. 06-212587

### DISCLOSURE OF THE INVENTION

### Problem to be Solved with the Invention

In order to impart flame retardant properties to dimethyl ether (DME) in Patent document 1, the weight ratio of carbon dioxide has been required to increase comparatively. The dust blower has been used in an inclined position or inverted position, and in order to blow off dust, etc. the dust blower has been continuously sprayed, and consequently, if the weight ratio of carbon dioxide is small, it may become difficult to continue spraying in a completely vaporized state. However, it is not easy to mix carbon dioxide into dimethyl ether with a high weight ratio, and maintain a homogeneous mixed state in a spray can. And the pressure resistant strength of the spray can is required to increase. In addition, there may occur another problem that carbon dioxide first escapes to make the quality of products instable and to damage feeling upon using.

Under the above circumstances, the present inventors have studied the measure of retaining a propellant prepared by combining carbon dioxide with dimethyl ether (DME), by an absorbent composed of an assembly of pulverized cellulose fibers. The present invention has an object of providing a spray product with a high quality, which does not use fluorocarbons, alternatives to fluorocarbons, etc., but uses a propellant exhibiting a smaller ozone-depleting potential and a smaller global warming potential, which is less expensive, and enables the improvement of the safety and liquid retention.

### Means for Solving Problem

A first aspect of the present invention is a spray product including a spray can having a spray nozzle, in which at least a propellant and an absorbent for retaining the propellant are charged,

the propellant is composed of a mixture of dimethyl ether and carbon dioxide,

the absorbent for retaining the propellant is composed of an assembly of pulverized cellulose fibers including at least 45 mass % of fine cellulose fibers having a fiber length of 0.35 mm or less.

Dimethyl ether (ozone-depleting potential is 0, global warming potential is 0.2), and carbon dioxide (ozone-depleting potential is 0, global warming potential is 1) as components of the propellant both exhibit a very small effect on the global environment. In addition, by mixing carbon dioxide that is non-flammable and has a high vapor pressure, flame retardant properties are imparted to the propellant, and the spraying pressure is increased. Furthermore, the liquid retention of the absorbent composed of the assembly of pulverized cellulose fibers is remarkably improved by virtue of a predetermined ratio of the fine cellulose fibers having a fiber length that is a predetermined length or less so as to absorb and retain the propellant in an interior of the spray can, thereby preventing the leakage thereof. Consequently, the effect of restraining the ignition becomes high, and coloring troubles due to the colored liquefied gas are prevented.

Therefore, by using an inexpensive propellant having a low environmental impact, and an absorbent excellent in liquid retention, a non-fluorocarbon spray product with a greatly improved safety and a stable quality that is sustainable can be provided.

In a second aspect of the present invention, the propellant is composed of a liquefied mixture gas that is prepared by mixing dimethyl ether and carbon dioxide such that the weight ratio of carbon dioxide ranges from 0.1 to 30 weight %.

By determining the mixing ratio of carbon dioxide to 0.1 weight % or more, liquid leakage can be prevented where the spray can is used in an inverted position, and the product pressure can be increased to at least that of the conventional propellant (HFC152a: approximately 0.50 MPa), whereas by determining the same to 30 weight % or less, the internal pressure of the spray can can be maintained to a proper pressure range.

In a third aspect of the present invention, the propellant is composed of a liquefied mixture gas that is prepared by mixing dimethyl ether and carbon dioxide such that the weight ratio of carbon dioxide ranges from 2 to 30 weight %.

By determining the mixing ratio of carbon dioxide to 2 weight % or more, liquid leakage can be highly prevented where the spray can is used in an inverted position, and the product pressure can be increased to at least that of the conventional propellant (HFC134a: approximately 0.58 MPa), and by determining the same to 30 weight % or less, the internal pressure of the spray can can be maintained to a proper pressure range.

In a fourth aspect of the present invention, the absorbent is formed into a columnar configuration.

The absorbent can be formed into a columnar configuration with dimensions suited to an inside diameter of the spray can so that the absorbent can be readily charged in the spray can and retained therein stably.

In a fifth aspect of the present invention, the absorbent is formed into a sheet-shaped configuration.

The sheet-shaped absorbent can have a freely selected configuration that is readily charged in an interior of the spray can.

In a sixth aspect of the present invention, the absorbent is composed of cellulose fibers including at least 45 mass % of fine cellulose fibers having a fiber length of 0.35 mm or less, and a fusion-bondable resin.

Where the fusion-bondable resin is mixed in the absorbent composed of cellulose fibers, the fibers can be fusion-bonded to each other by heating, thereby facilitating the formation of the absorbent.

In a seventh aspect of the present invention, the absorbent is composed of 70 through 95 mass % of cellulose fibers and 5 through 30 mass % of a fusion-bondable resin.

Where the composition ratio of the cellulose fibers and the fusion-bondable resin is determined in the above-described range, good formability can be obtained without obstructing good liquid retention.

In an eighth aspect of the present invention, the spray product according to one of the first through seventh aspects is used as a dust blower.

The spray product of the present invention can be preferably used as the dust blower, thereby providing an inexpensive non-fluorocarbon product effecting both safety and liquid retention.

### BRIEF EXPLANATION OF THE DRAWINGS

FIG. 1 shows one example of the arrangement of a dust blower to which the present invention is applied, and (a), (b) and (c) are respectively a side view, a longitudinal sectional view in an upright position, and a longitudinal sectional view in an inverted position of the dust blower.

FIG. 2 shows one example of the arrangement of a conventional dust blower, and (a), (b), (c) are respectively a longitudinal sectional view in an upright position, a longitudinal sectional view in an inverted position, and a longitudinal sectional view in an inclined position of the dust blower.

### BEST MODE FOR CARRYING OUT THE INVENTION

Hereinafter, the spray product in accordance with the present invention will be explained in detail.

The spray product in accordance with the present invention is provided by charging at least a propellant and an absorbent adapted to retain the propellant into a spray can having a spray nozzle, and is preferably used as a dust blower, for example.

A mixture of dimethyl ether and carbon dioxide is used as the propellant, and the absorbent adapted to retain the propellant is composed of an assembly of pulverized cellulose fibers. The pulverized cellulose fibers include at least 45 mass % of fine cellulose fibers having a fiber length of 0.35 mm or less. An assembly thereof is used as an absorbent with good absorbing properties and good liquid retention.

Dimethyl ether (DME) as one component of the propellant is the simplest ether expressed with the chemical formula of CH₃OCH₃, a colorless gas having a boiling point of −25.1° C., and chemically stable, and exhibits a low saturated vapor pressure, that is, 0.41 MPa at 20° C., and 0.688 MPa at 35° C. Consequently, upon applying pressure, it is readily liquefied so as to be used by charging the same in a metallic spray can exhibiting a relatively low compression strength without using a container with a high compression strength.

And dimethyl ether (DME) exhibits an ozone-depleting potential as small as 0, and a global warming potential as small as 0.2. When sprayed, the decomposition time in the air is about several tens of hours so as not to cause any greenhouse effects or any depletion of the ozone layer, and consequently, it is useful as the propellant with a smaller environmental impact, as compared with the conventional fluorocarbons and alternatives to fluorocarbons. Dimethyl ether (DME) is inflammable so that flames may be generated when solely used as the propellant in the vicinity of fire.

Therefore, in accordance with the present invention, by mixing carbon dioxide as another component with dimethyl ether (DME), fire-retardant properties are imparted. Carbon dioxide (CO₂) is a non-flammable gas, has a boiling point as low as −78.5° C., and exhibits a high saturated vapor pressure, that is, 5.733 MPa at 20° C., and about 8.32 MPa at 35° C. And it well dissolves in dimethyl ether (DME) so as to lower the possibility of the generation of flames, and raise the spraying pressure when charged as a liquefied mixture gas.

In addition, in order that this liquefied mixture gas can exhibit its effect preferably, in accordance with the present invention, the propellant is made to be retained with an absorbent having a specific composition. It is preferable to determine the mixing amount of carbon dioxide in the liquefied mixture gas ranges from 0.1 to 30 weight %. In the case that the mixing ratio of carbon dioxide is 0.1 weight % or more, by using the absorbent for retaining the propellant together, liquid leakage may not occur even where the spray can is used in an inverted position, and the product pressure can be increased to at least that of the conventional inflammable alternative to fluorocarbons (HFC152a: approximately 0.50 MPa). Consequently, spraying in a vaporized state can be maintained, regardless of the inclination upon using, whereby generation of flames caused by ignition can be prevented.

Whereas, in the case that the mixing ratio of carbon dioxide exceeds 30 weight %, the internal pressure of the spray can excessively increases, and consequently, normally available metallic spray cans may burst. By determining the mixing ratio of carbon dioxide to 30 weight % or less, the internal pressure of the spray can can be kept in a proper range.

It is preferable that the mixing ratio of carbon dioxide is determined to the range from 2 to 30 weight %. By determining the mixing ratio to 2 weight % or more, the product pressure can be increased to at least that of the conventional non-flammable alternative to fluorocarbons (HFC134a: approximately 0.58 MPa), and feeling upon spraying can be improved. It is more preferable that the mixing ratio of carbon dioxide is determined to the range of 3 to 30 weight %. By determining the same to 30 weight % or more, a higher product pressure can be effected, as compared with conventional propellants, and the effect of preventing liquid leakage upon using in an inverted position can be maintained over a long period of time, thereby improving the safety of the spray product.

And dimethyl ether (DME) and carbon dioxide as the components of the propellant are very inexpensive, as compared with fluorocarbons and alternatives to fluorocarbons. In particular, carbon dioxide as one component of the propellant is not required to newly produce, but carbon dioxide generated as a by-product during the step of refining oil, etc., or normally existing in the air can be used secondarily, similarly to the case of the production of dry ice, etc. so that it is advantageous in cost. Carbon dioxide becomes a greenhouse gas when emitted in the air, but this is the case where a large amount of exhaust gases are newly generated due to burning, etc. of petrochemical products. The spray product in accordance with the present invention uses carbon dioxide already existing in the air to achieve the effect of reducing the amount of carbon dioxide in the air, and even when carbon dioxide is emitted by spraying, the influence on the global warming (global warming potential of carbon dioxide=1) is much smaller than those of the conventional alternatives to fluorocarbons.

In accordance with the present invention, by composing the absorbent for retaining a propellant of an assembly of specific cellulose fibers, the absorbing properties and liquid retention of the liquefied mixture gas as the component of the propellant are enhanced, thereby preventing liquid leakage upon using or storing the spray products, and ensuring the safety thereof. Hereinafter, the absorbent will be explained in detail.

The absorbent used in the present invention mainly includes a pulverized cellulose, and the cellulose fibers include at least 45 mass % of the fine cellulose fibers having a fiber length of 0.35 mm or less. By determining the fiber length of the cellulose fibers to be 0.35 mm or less, the cellulose fibers are closely charged in the spray can as a fiber assembly, thereby improving the liquid retaining force. Where the fine cellulose fibers having a fiber length of 0.35 mm or less is included with less than 45 mass %, the absorbent is inferior in absorbing performance and liquid retention so that the liquid leakage prevention effect cannot be sufficiently achieved where the spray can is in an inverted position.

In accordance with the present invention, the term “fiber length” refers to the average fiber length measured with the fiber length analyzer FS-200 (Kajaani Process Measurements Ltd.).

The fine cellulose fibers having a fiber length of 0.35 mm or less, which are included in the absorbent in accordance with the present invention, are produced by pulverizing cellulose fibers as a raw material with mechanical and/or chemical means. By pulverizing the cellulose fibers, fine fibers with a large surface area can be obtained, whereby the liquid retention is improved.

Examples of the cellulose fibers as a raw material of the absorbent of the present invention include cellulose fibers of an arbitrary raw material such as a bleached or unbleached softwood or hardwood chemical pulp, a dissolving pulp, a waste paper pulp, cotton, etc. By pulverizing these cellulose fibers to obtain fibers having a predetermined fiber length, they can be used as the absorbent in accordance with the present invention. In particular, a bleached softwood kraft pulp (NBKP) and a bleached hardwood kraft pulp (LBKP) are excellent, because they exhibit good absorbing properties and good liquid retention, and do not cause any coloring of a liquefied gas, so as to be preferably used.

With respect to the waste paper pulp, the liquid retention of fibers thereof is slightly inferior, and there occurs the problem that a printing ink is attached to the fibers thereof, for example, but it has advantages such as low manufacturing costs, a small environmental impact, etc. Where the waste paper pulp is used, in order to obtain a desired liquid retention, it is desirable to increase the content or the charging amount of the fine cellulose fibers having a fiber length of 0.35 mm or less, or adopt various configurations as described later. In addition, the waste paper pulp can be used along with other raw material pulps without being used solely.

In order to mechanically pulverize cellulose fibers as a raw material, a high-speed impact pulverization method such as a rotary mill, a jet mill, etc., a roll crusher method, etc. have been mainly used. In addition, cellulose is an organic substance and accordingly is soft so that it is difficult to obtain fine cellulose particles with only the mechanical pulverization treatment, and in order to obtain fine cellulose fibers, a combination method of the chemical treatment and the mechanical pulverization has been generally used.

The combination method of the chemical treatment and the mechanical pulverization will be explained. It is generally known that cellulose is composed of a crystal region and a non-crystal region, and that the non-crystal region exhibits readily reactive properties on chemicals. It is known from these facts that by reacting cellulose on mineral acids, as the chemical treatment, the non-crystal region thereof liquates out, and consequently, the cellulose fibers mainly composed of a crystal part are obtained. And by further mechanically treating the cellulose fibers mainly composed of the crystal part, fine cellulose particles can be obtained. More specifically, there is the method of hydrolyzing a bleached pulp to a slight degree with acid, filtering, washing, drying and pulverizing the same, thereby producing cellulose fine particles, each partially including the crystal region. Alternatively, the method of hydrolyzing a refined pulp with hydrochloric acid or sulfuric acid and finely pulverizing only the crystal region thereof can be also adopted.

In accordance with the present invention, the cellulose fibers as a raw material are pulverized by the above-described mechanical means, chemical means or the combination method of the chemical means and the mechanical means so as to include at least 45 mass % of fine cellulose fibers having a fiber length of 0.35 mm or less. More specifically, by arbitrarily selecting the mechanical or chemical means upon pulverizing the cellulose fibers as the raw material, they can be pulverized so as to include at least 45 mass % of fine cellulose fibers having a fiber length of 0.35 mm or less.

In addition, it is preferable that the fine cellulose fibers having a fiber length of 0.35 mm or less can be included in at least 45 mass % by classifying the cellulose fibers previously pulverized using the mechanical or chemical means, or mixing another cellulose fibers to the classified fine cellulose fibers.

The cellulose fibers recovered from a bag filter upon producing a pulp air laid nonwoven fabric include a large amount of fine cellulose fibers so as to be able to be used as the raw material cellulose fibers or cellulose fibers to be mixed. As a result, the producing process can be made simple so as to be preferable.

The cellulose fiber assembly composing the absorbent in accordance with the present invention exhibits desired absorbing properties and liquid retention without using any pulverizing means, provided that at least 45 mass % of fine cellulose fibers having a fiber length of 0.35 mm or less is included therein, but, alternatively, the wet-type pulverizing method can be also used as the method capable of readily making the cellulose fibers subjected to the pulverizing treatment fine, and readily adjusting the properties such as fiber width, fiber length, water retaining force, etc.

According to a well known method for producing cellulose fibers having a fine fiber width, cellulose is changed to fine cellulose without causing any substantial chemical change in a starting material of cellulose by the step of passing a suspension of cellulose fibers through a small diameter orifice to impart an elevated speed to the suspension with a pressure difference of at least 3000 psi, and making the same collide to decelerate the same rapidly, thereby carrying out the cutting operation, and the step of repeating the above-described step to form a suspension that is substantially stable from the cellulose suspension, which corresponds to the method for treating a suspension of cellulose fibers with a high-pressure homogenization device (high pressure homogenizer) (See Patent Document 2 and Patent Document 3).

In addition, cellulose fibers can be also pulverized with a medium-stirring type wet pulverizer as the method capable of effectively minimizing the cellulose fibers with a shear force generated with a speed difference between media, based on the minimizing operation mechanisms (size reduction operation) of the cellulose fibers with the high-pressure homogenization device, in particular, shearing operation, cutting operation and friction operation (See Patent document 4).

The medium-stirring type wet pulverizer is the device by which media and cellulose fibers charged in a stationary pulverization container are stirred by rotating a stirring machine inserted in the pulverization container, thereby generating a shear stress to pulverize the cellulose fibers therewith. There are a tower-type, a tank-type, a feed tube-type, a manular-type, and other types of pulverization devices. Any device of these types can be used provided that a medium stirring mechanism is used. In particular, a sand grinder, an ultra visco mill, a dyno mill, and a diamond fine mill are preferable.

Available examples of the medium include glass beads, alumina beads, zirconia beads, zircon beads, steel beads, titania beads, etc., and the average particle diameter of available media ranges from 0.1 mm to 6 mm. The kind and the average particle diameter of the available media along with the treatment conditions such as the rotation speed of the pulverizer, the treating concentration, etc. can be arbitrarily selected according to desired physical properties of the fine cellulose fibers. In addition, any one of the batch-type method and the continuous type method may be used, and several devices may be connected in series such that cellulose is pulverized rough in a first stage, and then, pulverized fine in following stages.

In the case of the bleached hardwood kraft pulp as one example of the cellulose fibers, an untreated pulp thereof has a fiber width ranging from 20 to 30 μm with an average fiber length against weight load of about 0.8 mm and a smooth and flat cylindrical configuration that is twisted or bent. By treating such a pulp with the above-described pulverizing device, etc., pulverized cellulose including a large amount of fine cellulose fibers having a fiber length of 0.35 mm or less can be readily obtained. The pulverized cellulose thus obtained can be formed very fine such that the fiber width is 0.15 μm or less and the number average fiber length is 0.25 mm or less.

The fine cellulose fibers, each having a smaller fiber length, exhibit characteristics different from those of normally available pulp fibers, and consequently exhibit drastically excellent absorbing performance and liquid retaining force. This is probably because the fine cellulose fibers can exhibit properties such as an increased viscosity, an increased affinity with water, and an increased water retaining ability (water retaining force) as the cellulose fibers become finer.

For example, the cellulose fibers pulverized with the above-described medium-stirring type wet pulverizer normally exhibit a water retaining force of at least 210%. They exhibit ability as high as 300% or more according to pulverizing conditions.

In contrast, the water retaining force of the normally beaten pulp is lower than the above-described force. For example, the pulp fibers that were prepared by beating a bleached softwood kraft pulp (freeness is 710 ml and water retaining force is 51% before treated) with a refiner at a treating concentration of 2% so as to exhibit freeness (measured according to TAPPI standard T227 m-58) of 375 ml, 254 ml, 61 ml and 30 ml exhibited a water retaining force of 138%, 151%, 181% and 195%, respectively. And the pulp fibers that were prepared by treating a softwood sulfite kraft pulp (freeness is 705 ml and water retaining force is 72% before treated) with a Niagara beater at a treating concentration of 2% so as to exhibit freeness of 380 ml, 210 ml and 45 ml exhibited a water retaining force of 161%, 182% and 208%, respectively.

The absorbent in accordance with the present invention retains a liquefied mixture gas as a propellant. The liquid retention force thereof cannot be compared directly based on its water retaining force, but, the water retaining force increases as the absorbent becomes finer so that it can be estimated that the retention of components of the propellant has a tendency similar to the water retaining force.

The water retaining force is measured by dehydrating with a centrifugal treatment under 3000 G for 15 minutes, using a cylindrical centrifugal tube having an aperture in a bottom thereof and provided with a glass filter of G3, removing treated samples and measuring the mass of the cellulose samples. And, these samples are dried at 105° C. for at least 5 hours to measure the dry mass thereof. The water retaining force is the value obtained by reducing the dry sample mass from the sample mass in a wet state after the centrifugal treatment, dividing the reduced value by the dry sample mass, and multiplying the divided value by 100.

The absorbent for retaining a propellant, used in the present invention is composed of an assembly of pulverized cellulose fibers including at least 45 mass % of fine cellulose fibers having a fiber length of 0.35 mm or less. The fiber assembly can be charged in the spray can by an arbitrarily selected method. Therefore, by adjusting the obtained pulverized cellulose fibers to include a predetermined amount of fine cellulose fibers, and directly charging a predetermined amount of the pulverized cellulose fibers in the spray can according to the dimensions of the spray can, the absorbent for retaining a propellant can be obtained.

In addition, by previously assembling a fixed amount of the pulverized cellulose fibers, a fiber assembly can be also formed. It is more preferable to charge this fiber assembly in the spray can as the absorbent for retaining a propellant from the viewpoint of the workability and productivity. The fibers can be assembled by charging the pulverized cellulose fibers in bags made of sheets such as papers, nonwoven fabrics, etc., each exhibiting predetermined air permeability. By charging the fibers in the bags, formed bodies having predetermined configurations can be produced, thereby preventing the scattering of fibers in the producing step.

Where the absorbent is produced into a columnar formed body with dimensions conforming to the inside diameter of the spray can, it can be readily charged in the spray can, and stably retained therein during use.

In addition, the fiber assembly obtained by forming the pulverized cellulose fibers into a predetermined configuration with application of pressure can be used as the absorbent for retaining a propellant.

In this case, a preferred configuration of the absorbent is a sheet-shaped configuration. The absorbent produced by forming the pulverized cellulose fibers into the sheet-shaped configuration can be directly charged in the spray can, but, since the sheet-shaped configuration can be readily curved, after folding or winding the sheet-shaped absorbent into a columnar configuration conforming to the inside diameter of the spray can, it can be charged in the spray can.

Another preferred configuration of the absorbent in accordance with the present invention is a columnar configuration. After forming the pulverized cellulose fibers into a columnar configuration with a diameter suited to the inside diameter of the spray can, the columnar formed body can be charged in the spray can.

In order to form the absorbent composed of the pulverized cellulose fibers, it is necessary to bond the fibers to each other. Therefore, in order to obtain such an absorbent, it is desirable to add a material serving as a binder to a forming material.

More specifically, it is possible to adhere a binder such as a water-soluble resin to the pulverized cellulose fibers by the spraying method, etc., and accumulate it in a sheet-shaped configuration, or dry it while being placed in a forming die.

The binder can be selected arbitrarily according to needs. Examples of the binder include an aqueous solution-type binder such as casein, sodium alginate, hydroxyethyl cellulose, carboxymethy cellulose sodium salt, polyvinyl alcohol (PVA), polyacrylic acid sodium, etc., and an emulsion-type binder such as emulsions such as polyacrylic acid ester, acryl·styrene copolymer, polyvinyl acetate, ethylene, vinyl acetate copolymer, acrylonitryl·butadiene copolymer, methyl metaaclylate·butadiene copolymer, etc., styrene·butadiene copolymer latex, etc.

But, with this method, the surface of the fiber is coated with the binder, the performance of the absorbent may deteriorate, as compared with the case of no binder being used.

The pulverized cellulose fibers can be formed into a predetermined configuration by mixing a fusion-bondable resin in the pulverized cellulose fibers, and heating a mixture to fusion-bond the fibers to each other without using any binder. With this method, any binder, etc. do not adhere to surfaces of the fibers except for those in bonding areas of the cellulose fibers and the fusion-bondable fibers so that the absorbing performance of the absorbent does not deteriorate. In addition, this method is excellent in productivity, too so as to be preferable as the method for forming the absorbent in accordance with the present invention.

In this case, it is more desirable that the absorbent is composed of 70 through 95 mass % of cellulose fibers including at least 45 mass % of fine cellulose fibers having a fiber length of 0.35 mm or less, and 5 through 30 mass % of a fusion-bondable resin. Where the content of the fusion-bondable resin is less than 5 mass %, the bonding of the fibers composing the absorbent may become insufficient, thereby causing troubles such as production of a large amount of paper dust, etc. Whereas, when the content of the fusion-bondable resin exceeds 30 mass %, the absorbing properties and the liquid retention of the absorbent are deteriorated.

Any fusion-bondable resin can be used according to demands. Examples thereof include olefin fibers such as polyethylene (PE), polypropylene (PP), etc., polyester (PET) fibers, nylon fibers, etc. In addition, a complex fiber composed of a combination of synthetic resins having different melting points can be used. Examples of the combination of resins in the complex fiber include PE/PP, PE/PET, PP/PET, low melting point PET/PET, low melting point PP/PP, nylon-6/nylon-66, PP/PVA, PE/PVA, etc. The kind thereof can be arbitrarily selected. Alternatively, a side-by-side-type complex fiber in which different resins are spun in parallel, a sheath core type complex fiber in which a low melting resin is spun in an outside position thereof, and a high melting point resin is spun in an inside position thereof, etc. can be used, too.

And the fusion-bondable resin may take a granular configuration, but where it takes the fiber-shaped configuration, it is tangled with cellulose fibers so as to be difficult to come off the same, whereby merely a small amount of the fiber-shaped fusion-bondable resin can bond fibers by heat, which is more desirable.

The fiber length and the fiber diameter of various kinds of synthetic resins to be used as the fusion-bondable resin can be arbitrarily selected, but normally, synthetic resins, each having a fiber length ranging from 2 to 6 mm, and a fiber diameter ranging from 1 to 72 dt, preferably from 1 to 5 dt, can be used preferably.

In accordance with the present invention, it is desirable that the surface of the absorbent is covered with a surface sheet. In order not to obstruct the liquid absorbing properties of the absorbent, a sheet exhibiting air permeability, such as a sheet of paper, a nonwoven fabric, etc., is used as the surface sheet. The preferable weight of such a sheet ranges from 12 to 50 g/m². More specifically, examples of the nonwoven fabric include an air laid nonwoven fabric, a thermal bond nonwoven fabric, a spunlace nonwoven fabric, a spunbond nonwoven fabric, an air-through nonwoven fabric, a wet type nonwoven fabric, etc. and examples of the paper include tissue, kraft paper, crepe paper, etc. In accordance with the present invention, in particular, tissue, air laid nonwoven fabric, spunbond nonwoven fabric, etc. are preferably used.

As described before, the absorbent for retention of liquid is covered with the surface sheet by forming the sheet of paper, nonwoven fabric, etc. into a bag-shaped configuration, and putting a fiber assembly of pulverized cellulose fibers in this bag. With this method, the entire surface of the absorbent is covered with the surface sheet, the workability is good, and the absorbent readily achieves its performance so that this method is preferably carried out. And the absorbent can be also formed into a sheet-shaped configuration by a well known web forming method after mixing pulverized cellulose fibers and the fusion-bondable fibers with a desired composition ratio. In this case, these sheets composed of these papers, nonwoven fabrics, etc. are used as the surface material for the absorbent sheet, so as to serve as the surface sheet covering the surface of the absorbent.

Examples of the web forming method include the wet papermaking method, the air laid method of dispersing a raw material in the air to cause foaming thereof (representative producing processes are J&J method, K-C method, Honshu method (Kinocloth method), etc.), carding method, etc.

The absorbent sheet as the absorbent can be obtained by partially melting the fusion-bondable fibers of the web formed with these methods with a conventionally well known heat treating device to bond the fusion-bondable fibers to each other, and bond the cellulose fibers to the fusion-bondable fibers. Examples of the heat treating method include drying devices such as the through-air drier, Yankee drier, multi-cylinder drum drier, etc., or calendering devices such as the thermal calendering device, the thermal embossing device, etc.

More specifically, the method of forming a sheet-shaped absorbent by the web forming method is as follows. First, a surface sheet is drawn out on a mesh conveyer, cellulose fibers are defibrated with a dry web forming device to obtain cellulose fibers including 45 through 100 mass % of fine cellulose fibers having a fiber length of 0.35 mm or less, 70 through 95 mass % of the obtained cellulose fibers and 5 through 30 mass % of a fusion-bondable resin are blended, and the blended material is further mixed in the air, and is continuously accumulated on the surface sheet to form a web. Another surface sheet is further drawn out on the web as a lamination layer, and the web is heated in a heating furnace, thereby bonding the web to the surface sheets. This method is preferably used.

In particular, the spray product in accordance with the present invention is preferably used as a dust blower for blowing off dust attached to various kinds of appliances. Where the spray product is used as the dust blower, the composition ratio of the liquefied mixture gas composed of dimethyl ether and carbon dioxide as the propellant is adjusted to obtain a spraying pressure enough to blow off dust, and the propellant thus adjusted is charged in a metallic spray can together with the absorbent for retaining the propellant, which is prepared into a desired shape with desired dimensions by the above-described various methods.

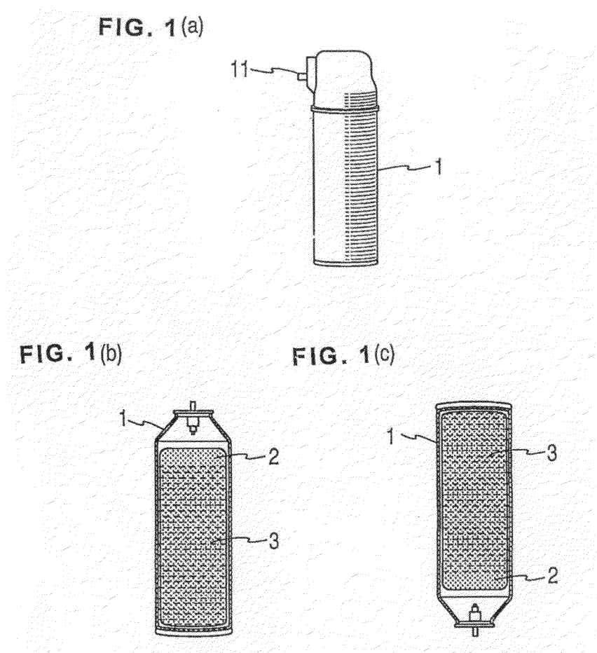

FIG. 1 shows one example of a dust blower to which the present invention is applied. FIG. 1 (a) and FIG. 1(b) are respectively a side view and a longitudinal sectional view of the dust blower. As shown, an absorbent (a special absorbent 2) for retaining a propellant, which is provided by charging cellulose fibers pulverized so as to include 45 mass % of fine cellulose fibers having a fiber length of 0.35 mm or less in a bag of a nonwoven sheet, for example, is accommodated in a spray can 1 having a spray nozzle 11 in a side surface of a head part thereof. The special absorbent 2 has a columnar configuration with a diameter approximately equal to the inside diameter of the spray can 1, the height thereof is less than that of a main part of the spray can 1 with a space remained on the side of the head part thereof. A liquefied mixture gas 3 as a propellant, which is composed of dimethyl ether and carbon dioxide, is accommodated in an interior of the spray can 1 while being retained with the pulverized cellulose fibers composing the special absorbent 2 along with gaps between fibers.

The dust blower to which the present invention is applied uses the liquefied mixture gas 3 (ozone-depleting potential is 0, and global warming potential is 1 or less), which is composed of dimethyl ether and carbon dioxide, as the propellant so that the environmental impact during using is small. And since the liquefied mixture gas 3 is retained with the special absorbent 2, it exhibits extremely high liquid retention and the using angle thereof is not limited specifically, liquid leakage can be effectively restrained upon used or stored in an inclined state or an inverted position. In addition, by using carbon dioxide, flame-retardant properties are imparted, and the spraying pressure can be adjusted to a desired pressure so that the safety of the dust blower is remarkably improved though inflammable dimethyl ether (DME) is used, and feeling upon using is also excellent. Therefore, non-fluorocarbon dust blowers with high qualities, which is friendly to global environment, can be provided at low prices.

Hereinafter, the liquid retention of the dust blower in accordance with the present invention will be explained with reference to FIG. 1 (b) and FIG. 1(c). FIG. 1 (b) is a view showing a dust blower in an upright position, in which a liquefied mixture gas 3 as a propellant is absorbed and retained on the lower side of the special absorbent 2 with its own weight. When the dust blower is inverted from this position, as shown in FIG. 1(c), the special absorbent 2 that includes 45 mass % or more of fine cellulose fibers having a fiber length of 0.35 mm or less absorbs the liquefied mixture gas 3 as a propellant to swell, and consequently, the special absorbent 2 is substantially secured in an interior of the spray can 1 without moving to define a space in the vicinity of the spray nozzle 11 in the lower position of the drawing. In addition, a vaporized gas corresponding to the internal pressure exists in the space defined in the vicinity of the spray nozzle 11 so that the liquefied mixture gas 3 retained in the special absorbent 2 only moves very slowly along the fine cellulose fibers having a fiber length of 0.35 mm or less, whereby liquid leakage may not be generated from the spray nozzle 11 upon using the dust blower in an inverted position.

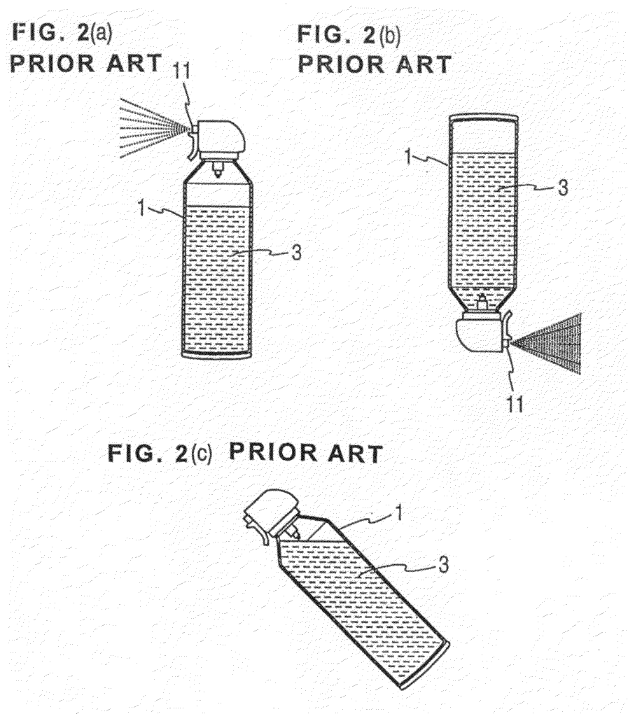

In contrast, when the conventional dust blower which does not use any absorbent is inverted, as shown in FIG. 2(a), a liquefied gas 3 readily moves in an interior of a spray can 1 so that liquid leaks from a spray nozzle 11. When the conventional dust blower is used in an inclined state (45°, for example), as shown in FIG. 2(b), liquid may leak according to the using angle and the amount of the liquefied gas 3, thereby lowering the safety of the dust blower. When the dust blower using an absorbent is used for a long time in an inverted state, the liquefied gas moves downwardly so that liquid may leak, similarly.

In accordance with the present invention, in order to charge the liquefied mixture gas 3 in the special absorbent 2, it is preferable to prepare the liquefied mixture gas 3 by previously dissolving carbon dioxide in dimethyl ether (DME), and make the special absorbent 2 accommodated in the spray can absorb the prepared liquefied mixture gas 3. With this method, dimethyl ether (DME) and carbon dioxide as components of the propellant are homogeneously retained over an entire part of the special absorbent 2 to exhibit the effect of restraining carbon dioxide from escaping from the spray can 1 prior to other components. In a preferred embodiment, such a producing method as to mix a liquefied DME in carbon dioxide that is in a supercritical state is adopted. With this method, vaporization is restrained in the producing process, thereby maintaining a prescribed mixing ratio.

Alternatively, an inorganic porous material that can retain carbon dioxide can be accommodated in the interior of the spray can 1 or integrally with the special absorbent 2. With this arrangement, the effect of restraining carbon dioxide from escaping can be much enhanced.

Therefore, in accordance with the present invention, non-fluorocarbon spray products of which safety is greatly improved, and of which stable quality is sustainable can be provided by using a propellant that exhibits a small environmental impact and is prepared at a low price, and an absorbent excellent in liquid retention.

The spray product in accordance with the present invention is preferably used as dust blowers, but can be also used as other products.

### EMBODIMENTS

Hereinafter, the present invention will be explained in more detail based on embodiments that were carried out to confirm the effects of the present invention.

### Embodiment 1

### (1) Production of Fine Cellulose Fibers

A suspension was prepared by adding bleached hardwood kraft pulp (LBKP) on the market to water to the concentration of 1.5%, and 120 g of the prepared suspension was subjected to wet pulverization by a 6 cylinder sand grinding machine (manufactured by Imex Company, with treating volume of 300 ml) in which 125 ml of glass beads having an average particle diameter of 0.7 mm were put as media at 2000 rpm as the number of revolution of a stirrer and for 40 minutes while adjusting the treating temperature to about 20° C.

The fiber length of LBKP on the market before treatment was about 0.61 mm, the fiber width thereof was 20 μm, and the water retaining force thereof was 44%. In contrast, the number average fiber length of the cellulose fibers after treatment was 0.25 mm, the fiber width thereof ranged from 1 to 2 μm, and the water retaining force thereof was 288° A), so that with the wet pulverization, pulverized cellulose fibers including a large amount of fine cellulose fibers having a fiber length of 0.35 mm or less can be obtained.

### (2) Production of Absorbent for Retaining a Propellant

85 g of fibers prepared by blending 55 mass % A) of cellulose fibers obtained by defibrating LBKP on the market with a dry type defibrating device, with 45 mass % A) of the pulverized cellulose fibers including a large amount of the fine cellulose fibers obtained in the process (1) were charged in a cylindrical bag composed of a thermal bond nonwoven fabric (manufactured by FUKUSUKE KOGYO CO., LTD., brand name: D-01518) of 18 g/m², thereby obtaining an absorbent having a generally columnar configuration with a diameter of about 6.3 cm.

Upon examining the distribution of the fiber length against an entire part of the cellulose fibers composing the absorbent, the ratio of the fine cellulose fibers having a fiber length of 0.35 mm or less was 48 mass % A).

### Embodiment 2

An absorbent was obtained in a similar manner to Embodiment 1, except that the composition ratio of the fine cellulose fibers was determined to be 60 mass %.

The ratio of the fine cellulose fibers having a fiber length of 0.35 mm or less to the entire part of the cellulose fibers composing the absorbent was 72 mass %.

### Embodiment 3

Cellulose fibers including 45 mass % of fine cellulose fibers with a fiber length of 0.35 mm or less were obtained by defibrating LBKP on the market with a dry type defibrating device and classifying the obtained cellulose fibers. An absorbent for retaining a propellant was obtained in a similar manner to Embodiment 1, using the cellulose fibers.

### Embodiment 4

Cellulose fibers including 60 mass % of fine cellulose fibers with a fiber length of 0.35 mm or less were obtained by defibrating LBKP on the market with a dry type defibrating device and classifying the obtained cellulose fibers. An absorbent for retaining a propellant was obtained in a similar manner to Embodiment 1, using the cellulose fibers.

### Embodiment 5

Cellulose fibers including at least 45 mass % of fine cellulose fibers with a fiber length of 0.35 mm or less were obtained by defibrating LBKP on the market with a dry type defibrating device and classifying the obtained cellulose fibers. 70 mass % of the above-described cellulose fibers and 30 mass % of fusion-bondable fibers (PE/PET sheath type fusion-bondable fibers, fiber length: 5 mm, fiber diameter: 2.2 dt, manufactured by CHISSO CORPORATION, brand name: ETC) were blended, and homogeneously mixed in the air, and an obtained mixture was dropped and accumulated on a surface sheet (tissue paper, 14 g/m², thickness: 0.15 mm, manufactured by NITTOKU CO.) drawn out on an endless mesh-shaped conveyer that is running, with an air laid type web forming device along with an air flow.

Another surface sheet identical to the above-described surface sheet was laminated to form a web. The web was passed through a through air drier of 138° C., and pressed to obtain an absorbent sheet of 340 g/m². The absorbent sheet thus obtained was formed into a coreless roll-shaped configuration (columnar configuration with a diameter of about 6.3 cm, 85 g), thereby obtaining an absorbent for retaining a propellant.

### Embodiment 6

Cellulose fibers including at least 45 mass % of fine cellulose fibers with a fiber length of 0.35 mm or less were obtained by defibrating LBKP on the market with a dry type defibrating device and classifying the obtained cellulose fibers. 70 mass % of the above-described cellulose fibers and 30 mass % of fusion-bondable fibers (PE/PET sheath type fusion-bondable fibers, fiber length: 5 mm, fiber diameter: 2.2 dt, manufactured by CHISSO CORPORATION, brand name: ETC) were blended, and 85 g of the blended fibers were put in a forming die having a cylindrical configuration with a diameter of 6.3 cm and a height of 17 cm, and formed by applying pressure and heat, thereby obtaining an absorbent for retaining a propellant with a columnar configuration.

### Embodiment 7

Cellulose fibers including at least 45 mass % of fine cellulose fibers with a fiber length of 0.35 mm or less were obtained by defibrating LBKP on the market with a dry type defibrating device and classifying the obtained cellulose fibers. The above-described cellulose fibers were dropped and accumulated on an endless mesh-shaped conveyer that is running, along with an air flow with an air laid type web forming device, thereby forming a web of 40 g/m². An EVA-based aqueous binder liquid was sprayed on the web with an air knife nozzle such that the solid part becomes 7 g/m², and was simultaneously sucked with a suction device from the lower side of the mesh-shaped conveyer.

The web to which the above-described binder had been sprayed was passed through a box-type hot-air drier of which the atmospheric temperature was determined to be 170° C., thereby bonding the fibers to each other. The web was inverted, an opposite surface to the surface first subjected to the spraying of the binder was subjected to the spraying with the binder, similarly, and the web was passed through the hot-air drier, thereby obtaining an absorbent sheet of 40 g/m². The absorbent sheet thus obtained was formed into a coreless roll configuration (columnar configuration with a diameter of about 6.3 cm, 85 g), thereby obtaining an absorbent for retaining the propellant.

### Embodiment 8

Cellulose fibers including 50 mass % of fine cellulose fibers with a fiber length of 0.35 mm or less were obtained by defibrating waste newspapers with a dry type defibrating device. 85 g of the cellulose fibers was charged in a bag of a nonwoven fabric, similarly to Embodiment 1, thereby obtaining an absorbent.

### Comparative Example 1

Cellulose fibers including 20 mass % of fine cellulose fibers with a fiber length of 0.35 mm or less were obtained by defibrating LBKP on the market with a dry type defibrating device and classifying the obtained cellulose fibers. An absorbent for retaining a propellant was obtained in a similar manner to Embodiment 1.

### Comparative Example 2

Cellulose fibers including 40 mass % of fine cellulose fibers with a fiber length of 0.35 mm or less were obtained by defibrating waste newspapers with a dry type defibrating device. An absorbent was obtained by spreading 75 g of the above-described cellulose fibers on a nonwoven fabric into a mat-like state, folding the same into two, forming the same into a columnar configuration, and fixing the same with a stapler.

### Comparative Example 3

Cellulose fibers including 40 mass % of fine cellulose fibers with a fiber length of 0.35 mm or less were obtained by defibrating waste newspapers, similarly to Comparative example 2, and an absorbent was obtained using 85 g of the above-described cellulose fibers, in a similar manner to Comparative example 2.

The absorbents for retaining a propellant, which were obtained in these embodiments and comparative examples, were respectively charged in spray cans along with a liquefied mixture gas of dimethyl ether (DME) and carbon dioxide, thereby producing dust blowers, and they were evaluated with the following method. The evaluation results are shown in TABLE 1.

<Liquid Leakage Evaluation Test>

The absorbents for retaining a propellant, which were obtained in the embodiments and the comparative examples were respectively charged in containers (outside diameter: 66 mm, height: 20 cm), each having a configuration identical to that of a spray can for use in a dust blower on the market, and after 350 ml of a liquefied mixture gas of dimethyl ether (DME) and carbon dioxide (dimethyl ether (DME): 98 weight %, carbon dioxide: 2 weight %) was further charged in the containers, they were allowed to stand for 24 hours. Then, the containers were inverted to spray charged gases, and the time until the liquid leakage occurred in spray parts of the containers was respectively measured.

The samples in which the time until the liquid leakage occurs is 20 seconds or more are available as the dust blowers, and were marked with “◯”. And the samples in which the liquid leakage occurs in less than 20 seconds cannot be used as dust blowers, and were marked with “x”.

<Evaluation of Discoloration>

The absorbents for retaining propellant obtained in the embodiments and the comparative examples and dimethyl ether (DME) were respectively put in test glass bottles for use in development of aerosols, sealed, and allowed to stand at room temperature for two weeks. Then, samples were evaluated whether DME were colored or not.

As shown in TABLE 1, Embodiments 1 through 8 of the dust blowers using assemblies of the cellulose fibers, each including 45 mass % or more of fine cellulose fibers with a fiber length of 0.35 mm or less, as the absorbents for retaining a propellant, were able to maintain the spraying for 20 seconds or more in an inverted position without generating liquid leakage. These results show that the absorbents of the embodiments exhibit sufficient performance as the dust blower, because It is considered that the inflammable gas used as the propellant in the dust blower catches fire due to incomplete vaporization of a sprayed liquefied gas, that each spraying time scarcely exceeds 20 seconds upon normally used, and that when continuously sprayed for 30 seconds or more, the spray can cannot be held with bare hands due to the temperature drop with vaporization heat. As a result, there can be provided dust blowers enabling the free selection of a spraying angle, restraining occurrence of flames due to liquid leakage, and exhibiting high safety and excellent feeling upon used.

In contrast, in Comparative examples 1 through 3, each including less than 45 mass % of fine cellulose fibers having a fiber length of 0.35 mm or less, liquid leakage occurred in 2 through 8 seconds. In Comparative examples 2 and 3 using conventional absorbents composed of waste newspapers, in particular, Comparative example 2 including a smaller amount of the absorbent, the time until the liquid leakage occurred was shorter. In addition, in Comparative examples 2 and 3, coloring also occurred.

Next. the dust blowers produced using various kinds of absorbents while varying the composition ratio of dimethyl ether (DME) and carbon dioxide composing the propellant were measured on the internal pressure, and evaluated on the inflammability. The results of the measurement and evaluation were shown in TABLE 2.

### (1) Preparation of Propellant

As shown in TABLE 2, propellants (samples 1 through 14) composed of a liquefied mixture gas of dimethyl ether and carbon dioxide were prepared while varying the composition ratio of carbon dioxide in the range of 0 to 30 weight %.

### (2) Production of Dust Blowers

Cellulose fibers were adjusted so as to include 45 mass % of fine cellulose fibers with a fiber length of 0.35 mm or less by defibrating LBKP on the market with a dry type defibrating device and classifying the obtained cellulose fibers. And, similarly, cellulose fibers including 60 mass % of fine cellulose fibers were obtained. 85 g of the obtained cellulose fibers were charged in a bag made of a non-woven fabric and formed into a columnar configuration, thereby preparing absorbents for retaining propellants.

Thus obtained absorbents were charged in spray cans, and the propellants of the samples 1 through 14 prepared in the step (1) were further charged therein in 350 ml in total.

### (3) Production of Dust Blowers for Comparison

For comparison, 75 g and 85 g of fibers obtained by defibrating waste newspapers were charged in bags made of non-woven fabrics, and the bags were folded into two, and fixed with a stapler, thereby producing the absorbents. The content of fine cellulose fibers (fiber length is 0.35 mm or less) in each case was 40 mass %. These absorbents were respectively charged in spray cans, similarly to the step (2), and propellants of samples 1 through 14 in the step (1) were further charged therein in 350 ml in total, thereby obtaining dust blowers (conventional absorbents). In addition, dust blowers (including no absorbent) were produced such that no absorbent was charged, but only the propellants of samples 1 through 14 in the step (1) were charged in the spray cans in 350 ml in total.

(Method for Measuring Internal Pressure)

After the dust blowers as the samples were immersed in a high temperature water bath of 25±0.5° C. for 30 minutes, spray buttons of the dust blowers were removed, stems were air-tightly inserted in an inlet port of a pressure gauge (JIS B 7505 Bourdon tube pressure gauge), and pressures were read to the first decimal place.

<Evaluation of Inflammability>

The inflammability was evaluated by carrying out tests while sample dust blowers were in an upright position or an inverted position, according to the flame length test of Aerosol Industrial Association of Japan, and evaluating the cases where no flame is observed as ⊚, the cases where the flame length is less than 20 cm as ◯, the cases where the flame length ranges from 20 cm to 40 cm as Δ, and the cases where the flame length is 40 cm or more as x.

The flame length test was carried out in the following processes (1) through (4).

1) The sample dust blowers were immersed in a thermostatic water bath of from 24 to 26° C. for 30 minutes such that the temperature of contents of the sample dust blowers is raised to the temperature of 24 to 26° C., and spray nozzles thereof were placed in the position 15 cm upwardly of a burner of a test device.
2) The flame length of the burner is adjusted to 4.5 cm or more and 5.5 cm or less, and the height of the burner is adjusted such that a lower part of sprayed contents pass an upper one/third of the flame of the burner,
3) Measurers are positioned away from side surfaces of the flame near a tip end and a base end of an estimated flame such that their eyes are located on a horizontal plane passing the spray nozzle.
4) Spraying is carried out under a best spraying condition by pushing the spray button. After 5 seconds, the tip end and the base end of the flame are dropped vertically, and the horizontal distance of the flame was measured (unit: cm) as the flame length. The flame length was measured thrice repeatedly.

The flame length was measured in the initial blowing period where the amount of the contents did not decrease, in the middle blowing period where the amount of the contents decreased to 50%, and in the final blowing period where the amount of the contents decreased by 80% with 20% of the contents remained, respectively.

In TABLE 2, the results of combustion tests of the dust blowers produced in the step (2) were indicated as “using absorbent”. As is clearly shown in TABLE 2, as the mixing amount of carbon dioxide in the liquefied mixture gas increases, the product pressure rises to enhance the liquid leakage restraining effect. In addition, with the dust blowers using the absorbents in accordance with the present invention, there is no difference in results of the combustion test between the upright position and the inverted position thereof even where the mixing amount of carbon dioxide in the liquefied mixture gas is small. These results show that the dust blowers in accordance with the present invention are excellent in liquid retention.

The dust blowers using the absorbents composed of 45 mass % and 60 mass % of fine cellulose fibers with a fiber length of 0.35 mm or less, respectively, showed similar test results.

More specifically, where the mixing amount of carbon dioxide is 0.1% or more (weight ratio), the evaluations of inflammability in the initial blowing period are ◯ both in the upright position and the inverted position, and consequently, the effects of restraining the generation of flames and improving the safety of the dust blowers are obtained. In addition, the production pressure exceeding that of the conventional inflammable alternative to fluorocarbons (HFC152a: approximately 0.50 MPa) can be obtained. In the case of 2 weight % or more, the product pressure becomes at least similar to that of the conventional non-flammable alternative to fluorocarbons (HFC134a: approximately 0.58 MPa). In the case of 3 weight % or more, the evaluations of inflammability both in the initial blowing period and in the middle blowing period become ◯, which shows that the safety of the dust blowers is improved.

In contrast, the dust blowers (using no absorbent or using conventional absorbents) that were produced for comparison are inferior in the evaluation of inflammability in the inverted position, as compared with that in the upright position. Until the mixing amount of carbon dioxide in the liquefied mixture gas exceeds 5 weight %, the evaluations of inflammability are all x, which shows that there exhibit problems in safety upon using them in the inverted position. Upon comparing the dust blowers using no absorbent and those using conventional absorbents with each other, the dust blowers using conventional absorbents are slightly longer in time until the liquid leakage occurs, but this difference was not so great as to affect the evaluation results.

TABLE 1

| | Sample | | | | | |
|---|---|---|---|---|---|---|
| | Embodiment | Embodiment | Embodiment | Embodiment | Embodiment | Embodiment |
| Item | 1 | 2 | 3 | 4 | 5 | 6 |
| Absorbent (g) | 85 | 85 | 85 | 85 | 85 | 85 |
| Test gas | DME + CO₂ | DME + CO₂ | DME + CO₂ | DME + CO₂ | DME + CO₂ | DME + CO₂ |
| Time until liquid leakage | 22 sec | 25 sec | 30 sec | 30 sec | 20 sec | 20 sec |
| (sec) | | | or more | or more | | |
| Evaluation of liquid leakage | ◯ | ◯ | ◯ | ◯ | ◯ | ◯ |
| Coloring | NO | NO | NO | NO | NO | NO |
| Raw material | LBKP | LBKP | LBKP | LBKP | LBKP | LBKP |
| Configuration | Columnar block charged in nonwoven fabric | | | | Coreless | Columnar |
| | | | | | columnar | shape by |
| | | | | | roll from | applying |
| | | | | | sheet | heat and |
| | | | | | | pressure |
| Covering material | Nonwoven | Nonwoven | Nonwoven | Nonwoven | Tissue | NO |
| | fabric | fabric | fabric | fabric | paper | |
| Classification of fibers | — | — | Carried out | Carried out | Carried out | Carried out |
| Composition ratio of dry | 55 | 40 | 100 | 100 | 70 | 70 |
| defibrated cellulose | | | | | | |
| Composition ratio of fine | 45 | 60 | | | | |
| cellulose (wet pulverization) | | | | | | |
| Composition ratio of fine | 48 | 72 | 45 | 60 | 45 ↑ | 45 ↑ |
| cellulose of 0.35 mm or less | | | | | | |
| Composition ratio of fusion- | | — | — | — | 30 | 30 |
| bondable fiber | | | | | | |
| Composition ratio of | — | — | — | — | — | — |
| aqueous binder | | | | | | |

| | Sample | | | | |
|---|---|---|---|---|---|
| | | | Comparative | Comparative | Comparative |
| | Embodiment | Embodiment | Example | Example | Example |
| Item | 7 | 8 | 1 | 2 | 3 |
| Absorbent (g) | 85 | 85 | 85 | 75 | 85 |
| Test gas | DME + CO₂ | DME + CO₂ | DME + CO₂ | DME + CO₂ | OME + CO₂ |
| Time until liquid leakage | 20 sec | 20 sec | about 8 sec | about 2 sec | about 5 sec |
| (sec) | | | | | |
| Evaluation of liquid leakage | ◯ | ◯ | X | X | X |
| Coloring | NO | Visible | NO | Visible | Visible |
| Raw material | LBKP | Waste | LBKP | Waste | Waste |
| | | newspaper | | newspaper | newspaper |
| Configuration | Coreless | Columnar | Columnar | Columnar | Columnar |
| | columnar | block | block | shape by | shape by |
| | roll from | charged in | charged in | folding mat | folding mat |
| | sheet | nonwoven | nonwoven | into two and | into two and |
| | | fabric | fabric | stapling | stapling |
| Covering material | NO | Nonwoven | Nonwoven | Nonwoven | Nonwoven |
| | | fabric | fabric | fabric | fabric |
| Classification of fibers | Carried out | Carried out | Carried out | — | — |
| Composition ratio of dry | 82.5 | 100 | 100 | 100 | 100 |
| defibrated cellulose | | | | | |
| Composition ratio of fine | | | | | |
| cellulose (wet pulverization) | | | | | |
| Composition ratio of fine | 45 ↑ | 50 | 20 | 40 | 40 |
| cellulose of 0.35 mm or less | | | | | |
| Composition ratio of fusion- | — | — | — | — | — |
| bondable fiber | | | | | |
| Composition ratio of | 17.5 | — | — | — | — |
| aqueous binder | | | | | |

TABLE 2

| | Sample | | | | | | | | | | | | | |
|---|---|---|---|---|---|---|---|---|---|---|---|---|---|---|
| Item | Sample 1 | | Sample 2 | | Sample 3 | | Sample 4 | | Sample 5 | | Sample 6 | | Sample 7 | |
| DME(wt %) | 100.0 | | 99.9 | | 99.5 | | 99.0 | | 98.5 | | 98.0 | | 97.5 | |
| CO₂(Wt %) | 0.0 | | 0.1 | | 0.5 | | 1.0 | | 1.5 | | 2.0 | | 2.5 | |
| Pressure (Mpa) | 0.50 | | 0.505 | | 0.51 | | 054 | | 0.58 | | 0.56 | | 0.80 | |
| Combustion test | up- | in- | up- | in- | up- | in- | up- | in- | up- | in- | up- | in- | up- | in- |
| (no absorbent- | right | verted | right | verted | right | verted | right | verted | right | verted | right | verted | right | verted |
| conventional | | | | | | | | | | | | | | |
| absorbent) | | | | | | | | | | | | | | |
| initial blowing period | Δ | X | ◯ | X | ◯ | X | ◯ | X | ◯ | X | ◯ | X | ◯ | X |
| middle blowing period | Δ | X | Δ | X | Δ | X | Δ | X | Δ | X | Δ | X | Δ | X |
| final blowing period | Δ | X | Δ | X | Δ | X | Δ | X | Δ | X | Δ | X | Δ | X |
| Combustion test | up- | in- | up- | in- | up- | in- | up- | in- | up- | in- | up- | in- | up- | in- |
| (using absorbent) | right | verted | right | verted | right | verted | right | verted | right | verted | right | verted | right | verted |
| initial blowing period | Δ | Δ | ◯ | ◯ | ◯ | ◯ | ◯ | ◯ | ◯ | ◯ | ◯ | ◯ | ◯ | ◯ |
| middle blowing period | Δ | Δ | Δ | Δ | Δ | Δ | Δ | Δ | Δ | Δ | Δ | Δ | Δ | Δ |
| final blowing period | Δ | Δ | Δ | Δ | Δ | Δ | Δ | Δ | Δ | Δ | Δ | Δ | Δ | Δ |

| | Sample | | | | | | | | | | | | | |
|---|---|---|---|---|---|---|---|---|---|---|---|---|---|---|
| Item | Sample 8 | | Sample 9 | | Sample 10 | | Sample 11 | | Sample 12 | | Sample 13 | | Sample 14 | |
| DME(wt %) | 97.0 | | 96.0 | | 95.0 | | 90.0 | | 85.0 | | 80.0 | | 70.0 | |
| CO₂(Wt %) | 3.0 | | 4.0 | | 5.0 | | 10 | | 15 | | 20 | | 30 | |
| Pressure (Mpa) | 0.88 | | 0.93 | | 0.98 | | 1.18 | | 1.38 | | 1.68 | | 1.88 | |
| Combustion test | up- | in- | up- | in- | up- | in- | up- | in- | up- | in- | up- | in- | up- | in- |
| (no absorbent- | right | verted | right | verted | right | verted | right | verted | right | verted | right | verted | right | verted |
| conventional | | | | | | | | | | | | | | |
| absorbent) | | | | | | | | | | | | | | |
| initial blowing period | ◯ | X | ◯ | X | ◯ | X | ⊚ | ◯ | ⊚ | ◯ | ⊚ | ◯ | ⊚ | ⊚ |
| middle blowing period | ◯ | X | ◯ | X | ◯ | X | ◯ | X | ◯ | X | ⊚ | Δ | ⊚ | ◯ |
| final blowing period | Δ | X | Δ | X | Δ | X | Δ | X | ◯ | X | ◯ | X | ◯ | X |
| Combustion test | up- | in- | up- | in- | up- | in- | up- | in- | up- | in- | up- | in- | up- | in- |
| (using absorbent) | right | verted | right | verted | right | verted | right | verted | right | verted | right | verted | right | verted |
| initial blowing period | ◯ | ◯ | ◯ | ◯ | ◯ | ◯ | ⊚ | ⊚ | ⊚ | ⊚ | ⊚ | ⊚ | ⊚ | ⊚ |
| middle blowing period | ◯ | ◯ | ◯ | ◯ | ◯ | ◯ | ◯ | ◯ | ◯ | ◯ | ⊚ | ⊚ | ⊚ | ⊚ |
| final blowing period | Δ | Δ | Δ | Δ | Δ | Δ | Δ | Δ | ◯ | ◯ | ◯ | ◯ | ◯ | ◯ |

1. A spray product produced by charging at least a propellant and an absorbent for retaining the propellant in a spray can having a spray nozzle, characterized in that the propellant is composed of a mixture of dimethyl ether and carbon dioxide, and
the absorbent for retaining the propellant is composed of an assembly of pulverized cellulose fibers that includes at least 45 mass % of fine cellulose fibers having a fiber length of 0.35 mm or less.

2. A spray product as claimed in claim 1, wherein said propellant is composed of a liquefied mixture gas of dimethyl ether and carbon dioxide, and the weight ratio of carbon dioxide ranges from 0.1 to 30 weight %.

3. A spray product as claimed in claim 1, wherein said propellant is composed of a liquefied mixture gas of dimethyl ether and carbon dioxide, and the weight ratio of carbon dioxide ranges from 2 to 30 weight %.

4. A spray product as claimed in claim 1, wherein said absorbent is formed into a columnar configuration.

5. A spray product as claimed in claim 1, wherein said absorbent is formed into a sheet-shaped configuration.

6. A spray product as claimed in claim 1, wherein said absorbent is composed of cellulose fibers including at least 45 mass % of fine cellulose fibers having a fiber length of 0.35 mm or less, and a fusion-bondable resin.

7. A spray product as claimed in claim 6, wherein said absorbent is composed of 70 through 95 mass % of cellulose fibers and 5 through 30 mass % of a fusion-bondable resin.

8. A spray product as claimed in claim 1, wherein said spray product is used as a dust blower.
